(19) United States
(12) Patent Application Publication
(10) Pub. No.: US 2012/0045215 A1
(43) Pub. Date: Feb. 23, 2012

(54) MOBILE TERMINAL, SERVER AND COMMUNICATION METHOD

(75) Inventors: Dae Woong KIM, Seoul (KR); Ho Min JEON, Goyang-si (KR); Mi Jin KIM, Seoul (KR); Sung Yun KIM, Seoul (KR); Wang Seok SEON, Seoul (KR); Min Seok SONG, Seoul (KR); Hoo Dong LEE, Seoul (KR); Jae Woo HWANG, Seoul (KR)

(73) Assignee: PANTECH CO., LTD., Seoul (KR)

(21) Appl. No.: 13/185,320

(22) Filed: Jul. 18, 2011

(30) Foreign Application Priority Data
Aug. 19, 2010 (KR) 10-2010-0080539

(51) Int. Cl. H04B 10/10; H04W 64/00

(52) U.S. Cl. 398/128

(57) ABSTRACT

Disclosed herein are a mobile terminal and server and a communication method. In an exemplary embodiment, a mobile terminal includes a light reception unit that receive visible light; a communication unit that performs communication using the visible light received by the light reception unit; and a control unit that controls a network to be formed by transmitting/receiving information to/from one or more other mobile terminals using the same light source through the communication unit.

### CROSS-REFERENCE TO RELATED APPLICATION

This application claims priority from and the benefit under 35 U.S.C. §119(a) of Korean Patent Application No. 10-2010-0080539, filed on Aug. 19, 2010, which is hereby incorporated by reference for all purposes as if fully set forth herein.

### BACKGROUND

1. Field

Exemplary embodiments of the present invention relate to a mobile terminal, network and communication based on visible light and a communication method.

2. Discussion of the Background

As the light emitting efficiency of light emitting diodes (LEDs) improves and prices therefore decrease, LEDs have recently been more widely used, such as in portable devices, displays, automobiles, traffic lights, notice boards, fluorescent lamps and incandescent electric lamps. Interest has increased in optical wireless technologies complementary to radio frequency (RF) technologies due to the exhaustion of RF band frequencies, potential crosstalk between several wireless communication technologies, an increasing demand for communication security, the advent of an ultra-high speed ubiquitous communication environment based on 4G wireless technologies, and the like. Visible light wireless communication using a visible light LED have been conducted recently, and visible light communication, which is information delivered using visible light, advantageously provides secure communication, and may be used as broadband, and can be freely used without any regulation. Further the places where visible light reaches or the direction in which visible light travels can be seen by the naked eye, and thus the reception range of information transmitted by visible light communication can be ascertained. Visible light communication can provide reliable security, and can be driven with low power consumption. Therefore, the visible light communication may be applied in locations that require security and low power consumptions, such as hospitals. Visible light communication may also be used in airplanes, where RF usage is restricted and discouraged, and may provide additional information services via an electric bulletin board.

### SUMMARY OF THE INVENTION

The following description relates to a mobile terminal and a communication method.

Exemplary embodiments provide a mobile terminal, the terminal including a light reception unit to receive visible light from a light source; a communication unit to perform communication via the visible light; and a control unit to control the light source to create a network in which information is transmitted and received to and from another mobile terminal through the communication unit.

Exemplary embodiments also provide a communication method for a mobile terminal, the method including receiving visible light from a light source; communicating via the visible light; and transmitting and receiving information to and from another mobile terminal using the visible light.

Exemplary embodiments also provide a server, including a light source to radiate visible light; a communication unit to communicate the visible light to mobile terminals with a specific range; and a geomagnetic sensor to determine location based on the visible light, wherein the light source has a first light reference source and a second light reference source.

As described above, in the mobile terminal based on the visible light communication and the communication method using the same according to the exemplary embodiments, a local network may be shared between mobile terminals using the same light source, so that it is possible to provide various services for obtaining location information of the mobile terminals, forming a social network service (SNS), and the like.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a configuration view of a mobile terminal based on visible light communication according to an exemplary embodiment.

FIG. 2 is a configuration view illustrating a network configured using mobile terminals according to an exemplary embodiment.

FIG. 3 is a flowchart illustrating a communication process using a mobile terminal according to an exemplary embodiment.

FIG. 4 is a flowchart illustrating a communication process using the mobile terminal according to an exemplary embodiment.

FIG. 5A, FIG. 5B, FIG. 5C, FIG. 5D, FIG. 5E and FIG. 5F are views illustrating a process of calculating location information of a mobile terminal according to an exemplary embodiment.

FIG. 6 is a view illustrating a process of providing a social network service (SNS) using a mobile terminal according to an exemplary embodiment.

FIG. 7 is a view illustrating a display screen of a mobile terminal that forms a network based on the visible light communication according to an exemplary embodiment.

### DETAILED DESCRIPTION OF THE ILLUSTRATED EMBODIMENTS

Exemplary embodiments will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

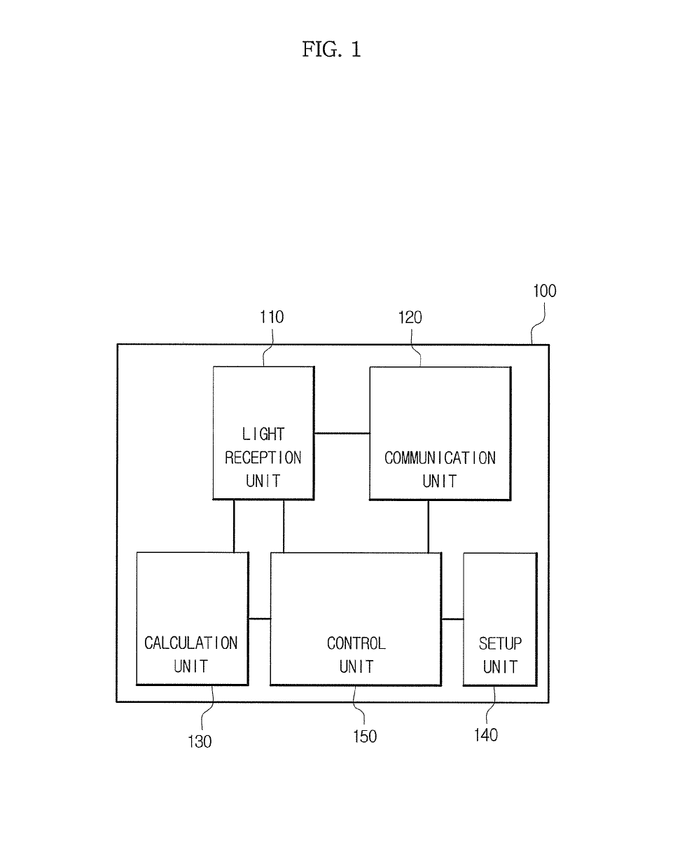

FIG. 1 is a configuration view of a mobile terminal according to an exemplary embodiment.

Referring to FIG. 1, the mobile terminal 100 that communicates via visible light communication includes a light reception unit 110, a communication unit 120, a calculation unit 130, a setup unit 140 and a control unit 150.

The light reception unit 110 receives visible light, and the communication unit 120 performs communication using the visible light received by the light reception unit 110. The visible light communication is a communication technology using the region of light visible to the human eye (for example, about 400 nm to about 700 nm). However, aspects are not limited thereto such that any ranges of light within the visible spectrum may be used, for example 400 nm to 450 nm, or 550 nm to 650 nm, and the like, and other wavelengths of light may be used. With visible light communication, information delivery is performed by flickering light, at a speed invisible to the human eye, the light being emitted from a fluorescent lamp or visible light emitted from a light emitting diode (LED), that may be used in a display device or the like. The visible light communication is safer and more secure than communication based on a wireless local area network (WLAN), because due to the blocking of light information is not leaked to the outdoors. Also, the visible light communication has low interference with a conventional wireless radio frequency (RF) and is generally not harmful to human health. Although mobile terminals are simultaneously used, the communication speed of the visible light communication may not be reduced.

The calculation unit 130 calculates location information of the mobile terminal 100 through a vector calculation that uses the visible light received by the light reception unit 110. The location information may be represented as a relative location from a light source to the mobile terminal 100. The exact location information of the mobile terminal using the same light source may be obtained through the calculation process of the calculation unit 130.

The setup unit 140 may set up the presence and range of information sharing between the mobile terminal 100 and other mobile terminals. In this example, the range of information may be the amount of information shared between mobile terminals. However, range of information may refer to other aspects of sharing between the mobile terminal 100 and other mobile terminals.

The control unit 150 controls a network that transmits and receives information to/from one or more mobile terminals using the same light source through the communication unit 120. In this instance, the control unit 150 may transmit/receive information using location or distance information between the mobile terminals, which may be obtained by using the location information calculated by the calculation unit 130. Specifically, the control unit 150 may control the mobile terminal 100 to communicate with a mobile terminal located closest to the mobile terminal 100 or the other mobile terminal located at a specific position by using the location or distance information. In a case where the mobile terminal 100 is configured to control a server or light source, the control unit 150 may control the light source that is in a disabled state to transition to an enabled state, thereby activating the visible light communication for use. The control unit 150 may transmit network connection information, such as an IP address or key, so that the one or more other mobile terminals using the same light source can be connected to the network via the light source. Each of the other mobile terminals may include the control unit 150 having the same or similar abilities, and the control unit 150 of the other mobile terminal that receives the network connection information may be connected to the network by determining whether the other mobile terminal is to be connected to the network. Thus, a local network may be configured with the mobile terminals using the visible light. The local network may be limited to those devices that are within range of the visible light. If the network is formed, the control unit 150 of one of the mobile devices may transmit command information to the one or more other mobile terminals that form the network through the light source and receive information of the other mobile terminals that form the network via visible light. If the presence and range of the information sharing is set by the setup unit 140, the control unit 150 shares information in the range authorized and set with other mobile terminals authorized to share information. In this case, a social network may be configured and setup, thereby performing and providing a social network service (SNS). In this case, the control unit 150 may share additional information with the other mobile terminals by determining a sharing operation based on the affinity level with the other mobile terminals that form the network corresponding to the range of the information sharing. The sharing step based on the affinity level may be readjusted according to maintenance time of each of the mobile terminals connected to the network, position information of each of the mobile terminals, distance information between the mobile terminals, data information shared between the mobile terminals, or the like. The control unit 150 may transmit request information to identify the presence of network connection to the other mobile terminals based on a period, that may be set by a user, to determine whether an arbitrary mobile terminal is connected to the network.

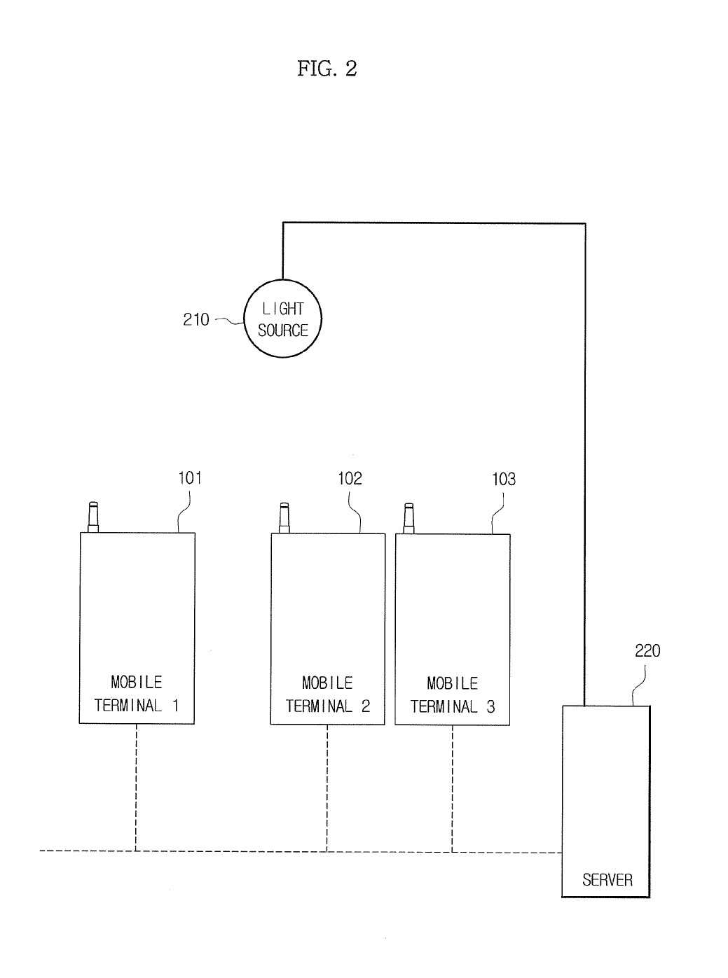

FIG. 2 is a configuration view illustrating a network configured using mobile terminals according to an exemplary embodiment.

Referring to FIG. 2, the network includes first, second and third mobile terminals 101, 102 and 103 that communicate via visible light communication, a light source 210 to radiate visible light, and a visible light server 220 to control the light source 210.

The network according to an exemplary embodiment may include the first mobile terminal 101 that may be a master mobile terminal capable of controlling the light source 210 and/or the visible light server 220. In a case where the light source 210 is in a disabled state, the first mobile terminal 101 may control the light source 210 to transition to an enabled state. If the light source 210 changes state, an area to which the visible light is radiated from the light source 210 may become a local network (or a virtual local network), and the first mobile terminal 101 transmits network connection information to the second and third mobile terminals 102 and 103 via the light source 210 which is controlled by the visible light server 220. The second and third mobile terminals 102 and 103 determine whether to be connected to the local network. The other mobile terminals for which connection is determined may be connected to the network using the received network connection information. If the other mobile terminals are connected to the network, information of the other mobile terminals connected to the network is reported to the visible light server 220 and may be transmitted to the first, second and third mobile terminals 101, 102 and 103. Therefore, for the purposes of the discussion below, the various terminals may communicate with each other terminal through visible light and form a network. The first mobile terminal 101 transmits information of the mobile terminal or command information to the second and third mobile terminals 102 and 103. Also, information communication can be performed between the second and third mobile terminals 102 and 103. In a case where the second mobile terminal 102 is intended to transmit arbitrary information, it may transmit the information of the mobile terminal to be received and information to be transmitted through the visible light server 220. If the network exists, the first mobile terminal 101 may transmit through the visible light server 220 a request signal in a period to the second and third mobile terminals 102 and 103. The second and third mobile terminals 102 and 103 that receive the request signal transmitted from the first mobile terminal 101 may transmit an acknowledgement (ACK) signal corresponding to the request signal, so as to determine whether or not to be connected to the network. In a case where a mobile terminal does not transmit the ACK signal during a specific reference time, it is determined that the connection of the mobile terminal to the network is released, and therefore, the mobile terminal may be deleted on network connection lists, that may be stored in the visible light server 220 and/or the first mobile terminal 101. If there exists no master mobile terminal having authority capable of controlling the light source 210 and the visible light server 220, the visible light server 220 may transmit the network connection information to the mobile terminals using the same light source 210 through the light source 210. Through the aforementioned method, conference data may be shared in a conference room using the same light source, or lecture data may be shared in a lecture room using the same light source. Also, a command for limiting a specific service including Internet, game or the like may be transmitted to mobile terminals using the same light source. Through the aforementioned method, environment setup information of mobile terminals, such as silent mode setup, may be forcibly changed or set in an arbitrary or specific space using the same light source. Also, the presence of network connection of mobile terminals may be identified in real time so that it is possible to perform attendance/absence management in a lecture room using the same light source and to localize locations of mobile terminals using the same light source.

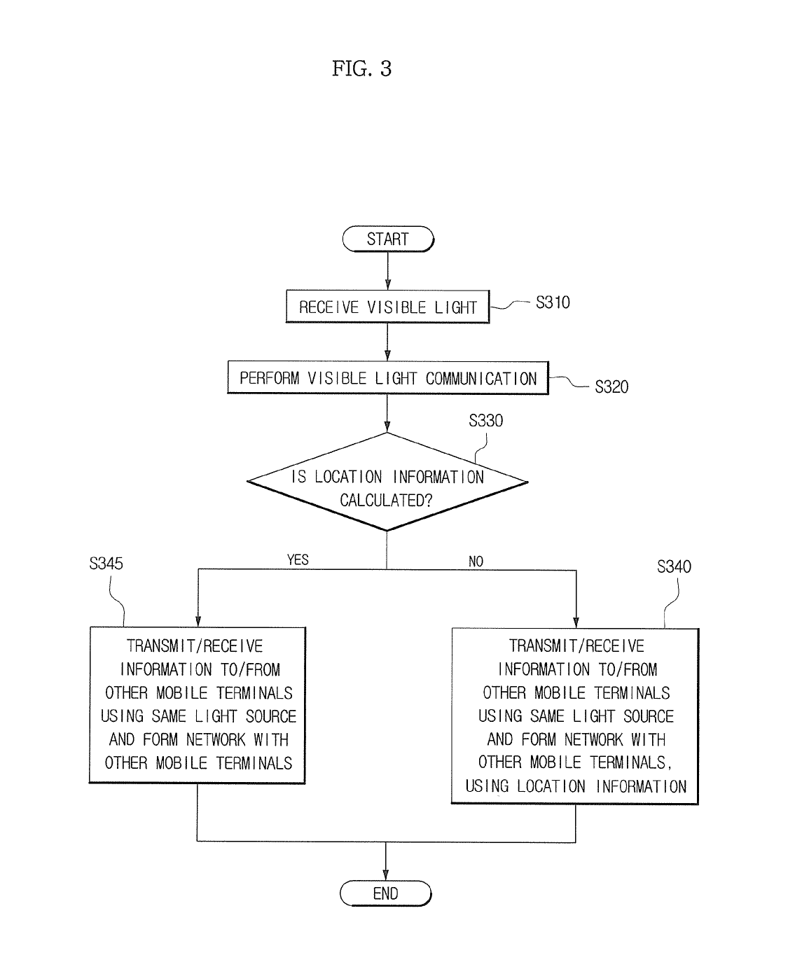

FIG. 3 is a flowchart illustrating a communication process using a mobile terminal according to an exemplary embodiment.

Referring to FIG. 3, the mobile terminal receives visible light radiated from a light source (S310) and performs visible light communication using the received visible light (S320). The mobile terminal transmits/receives information to/from other mobile terminals using the same light source and defines a network with the other mobile terminals (S340). The location information of the mobile terminal may be calculated through a vector calculation using the visible light. In a case where the calculated location information exists (S330), the mobile terminal transmits/receives information to/from other mobile terminals using the same light source and defines a network with the other mobile terminals, using the location information (S345). Specifically, the mobile terminal may receive information of the other mobile terminals that define the network, and may periodically transmit a request signal so as to identify the presence of network connection of the other mobile terminals. In order to share information with the other mobile terminals that form the network, the mobile terminal may set up the presence and range of information sharing with the other mobile terminals, and may share information with the other terminals based on the setup.

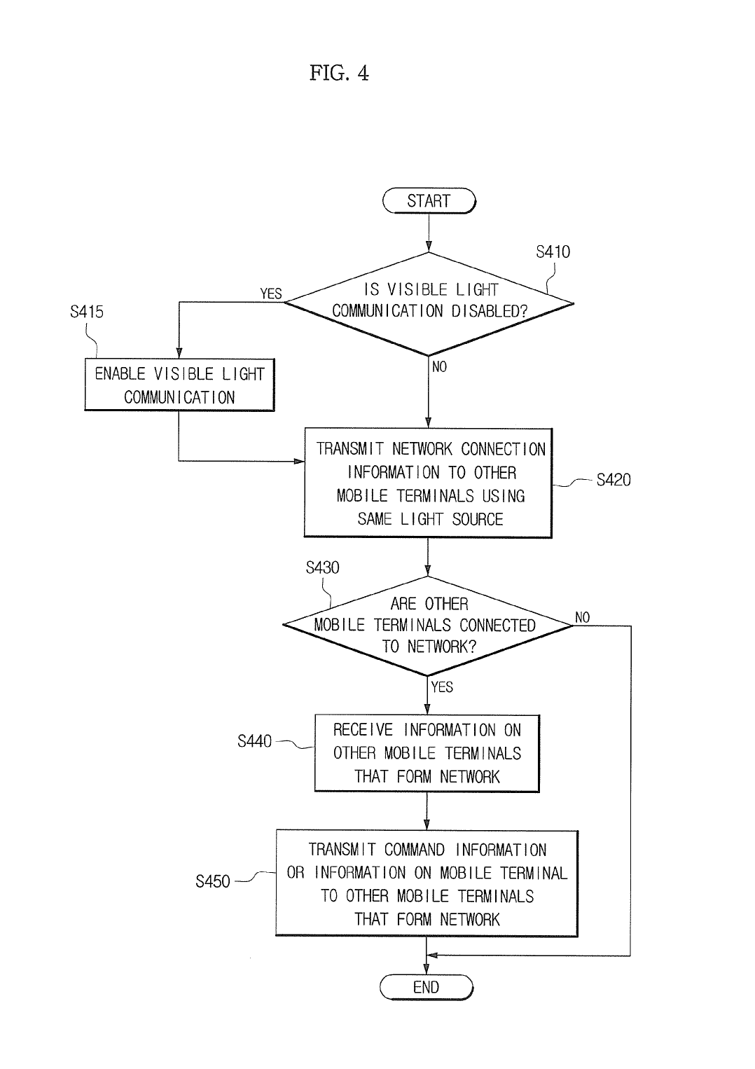

FIG. 4 is a flowchart illustrating a communication process using the mobile terminal according to an exemplary embodiment.

Referring to FIG. 4, visible light communication is performed and made possible by a mobile terminal capable of controlling a light source and a visible light server. If the visible light communication is in a disabled state (S410), the disabled state of the visible light communication is transitioned into an enabled state (S415). The mobile terminal transmits network connection information to other mobile terminals using the same light source via the visible light (S420). If the other mobile terminals are connected to a network (S430), the mobile terminal receives information on the other mobile terminals (S440). The mobile terminal transmits command information or information of the mobile terminal to the other mobile terminals connected to the network, using the received information, (S450). Thus, the mobile terminal can transmit/receive information to the other mobile terminals using the same light. Although described as communication via a same light, aspects are not limited thereto such that multiple lights may be used for communication.

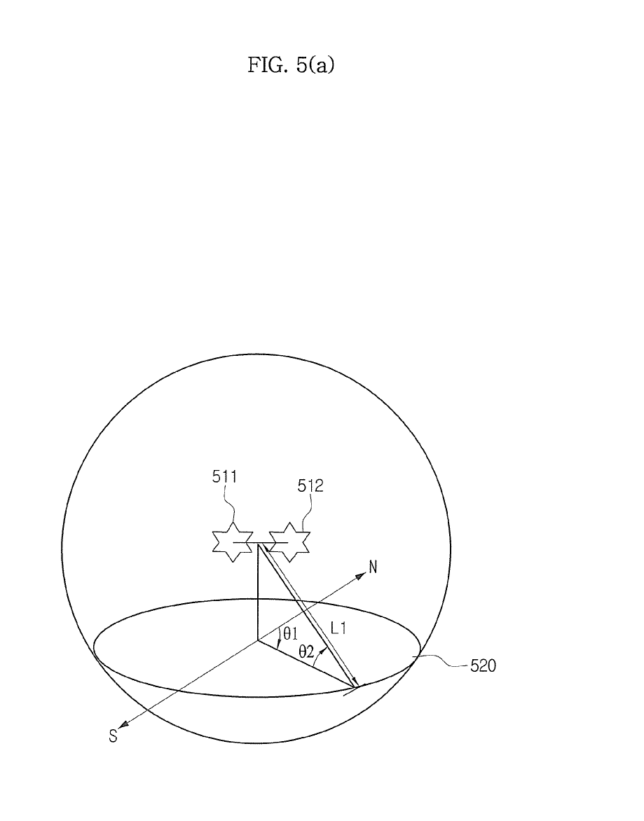

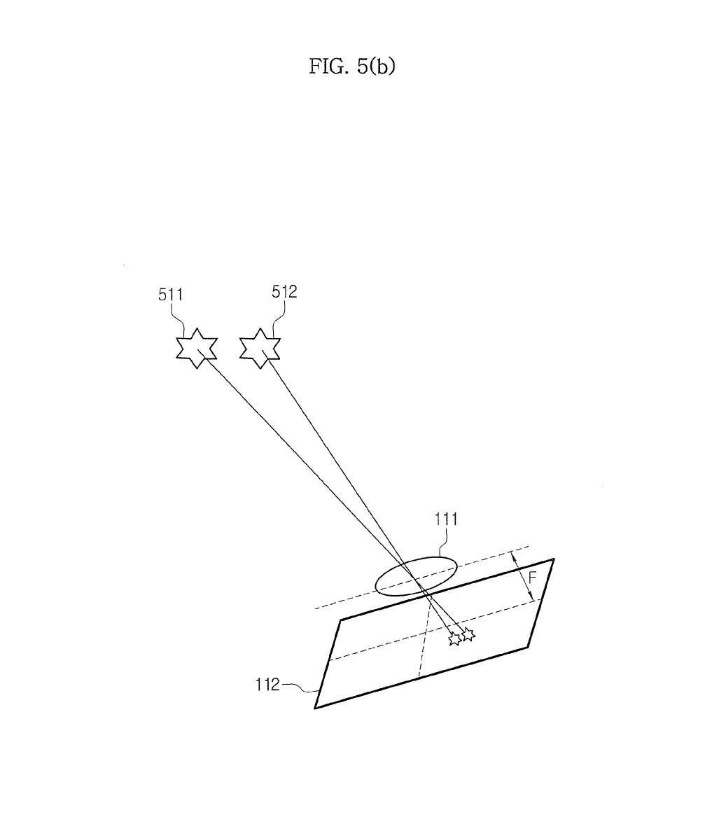

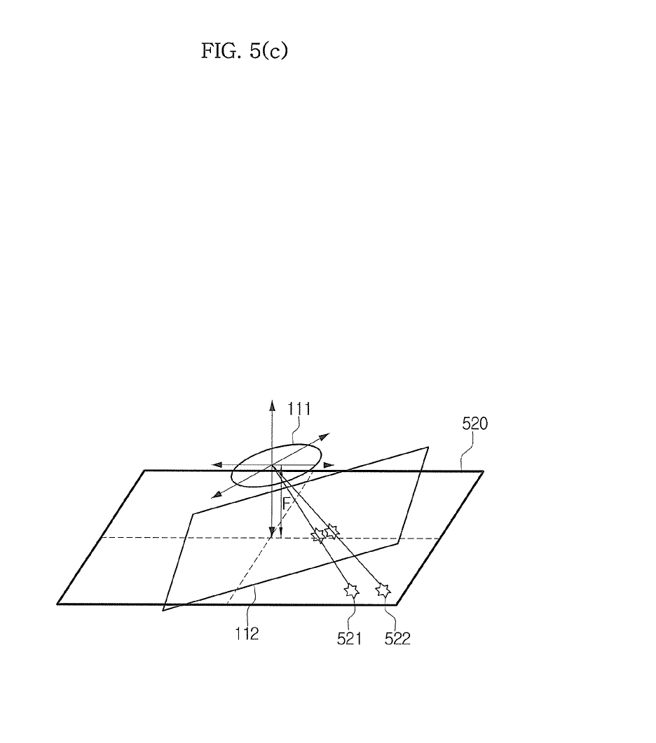

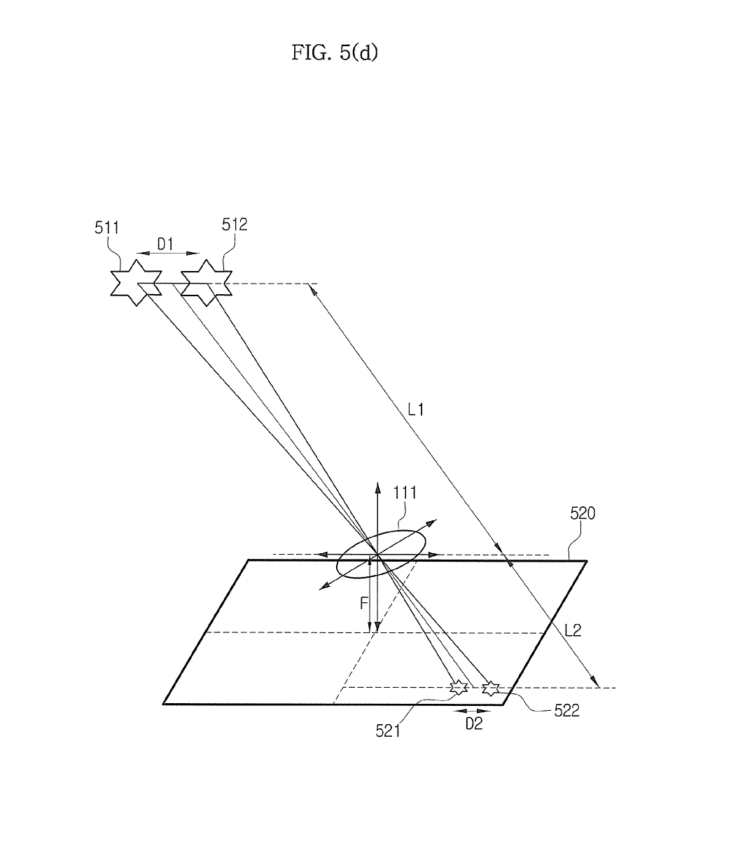

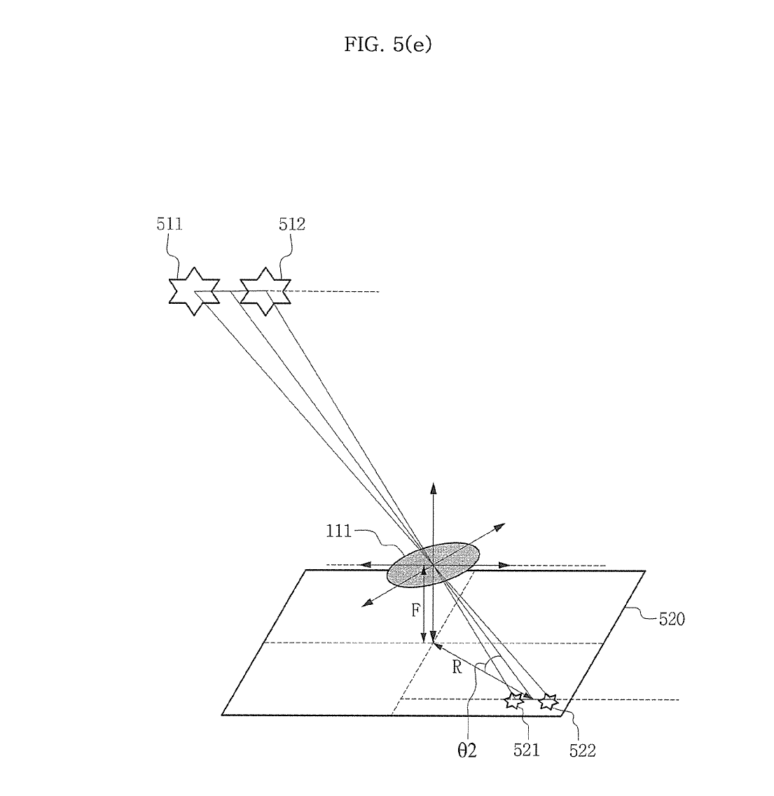

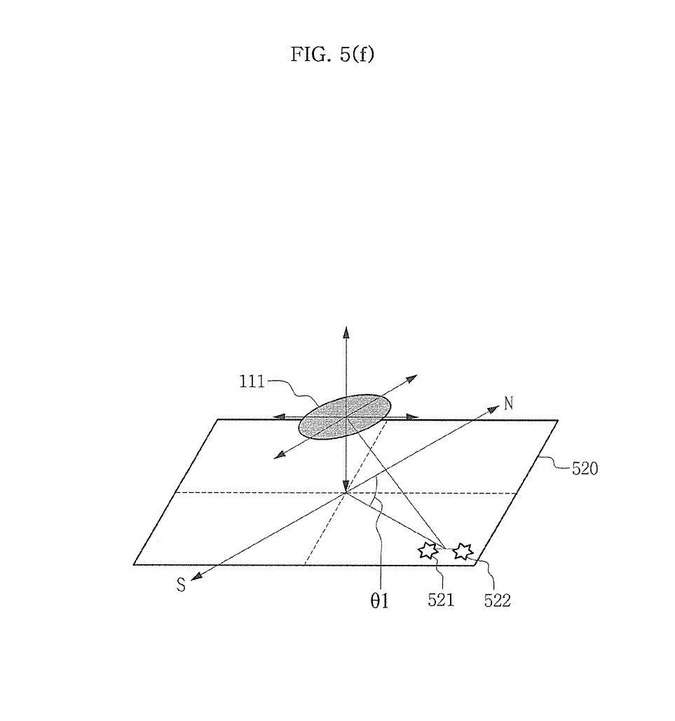

FIG. 5A, FIG. 5B, FIG. 5C, FIG. 5D, FIG. 5E and FIG. 5F are views illustrating a process of calculating location information of a mobile terminal based on the visible light communication according to exemplary embodiments.

Referring to FIG. 5A, Two light sources 511 and 512 may radiate visible light to a light reception unit (not shown) that receives the visible light. Further, a distance L1 from the two light sources 511 and 512 to the light reception unit, an incident angle θ2 of the light sources 511 and 512, and an angle θ1 between an azimuth in the true north direction and the light sources 511 and 512 are defined and used to calculate the location information of the mobile terminal.

Referring to FIG. 5B, in order to calculate the distance L1 to the light reception unit, the two light sources 511 and 512 radiate visible light via a light reception lens 111 and a light reception plane 112 in the light reception unit of the mobile terminal.

In FIG. 5C, the light reception lens 111 and the light reception plane 112 may be disposed at various positions and angles in space, and hence, the horizontal plane 520, that is at a distance F between the light reception lens 111 and the light reception plane 112 is used as a reference for calculating the location information. In this instance, angle difference information between the light reception plane 112 and the reference plane 520 may be calculated using a geomagnetic sensor or the like.

Referring to FIG. 5D, in order to calculate the distance L1, a distance from the center point between the two light sources 511 and 512 to the center point of the light reception lens 111 is defined as L1, and the distance from the center point of the light reception lens 111 to the center point between reception positions of two beams radiated onto the reference plane 520 is defined as L2. Also, the distance between the two light sources 511 and 512 is defined as D1, and the distance between the reception positions of the two beams radiated onto the reference plane 520 is defined as D2. Through the aforementioned definition, the relation among the L1, L2, D1 and D2 may be defined as the following proportional expression, as shown in Equation 1:

L1:L2=D1:D2 [Equation 1]

According to the Equation 1, the distance L1 from the two light sources 511 and 512 to the light reception unit may be calculated using the distance L2 from the center point of the light reception lens 111 to the center point between the reception positions of the two beam radiated onto the reference plane 520, the distance D1 between the two light sources 511 and 512, and the distance D2 between the reception positions of the two beam radiated onto the reference plane 520.

Referring to FIG. 5E, in order to calculate the incident angle θ2 of the light sources 511 and 512 that radiate the visible light, the distance from the center point of the light reception lens 111 to the reference plane 520 is defined as F, and the distance from the center point of the reference plane 520 to the center point between the reception positions 521 and 522 is defined as R. The incident angle θ2 may be defined with either Equation 2 or 3:

$$\begin{matrix}tan ( θ 2 ) = \frac{F}{R} & [ Equation 2 ] \\ cos ( θ 2 ) = \frac{R}{\sqrt{( {F}^{2} + {R}^{2} )}} & [ Equation 3 ]\end{matrix}$$

According to the Equation 2 or 3, the incident angle θ2 of the light sources 511 and 512 may be calculated using the distance F from the center point of the light reception lens 111 to the reference plane 520 and the distance R from the center point of the reference plane 520 to the center point between the reception positions 521 and 522.

Referring to FIG. 5F, the angle θ1 between the azimuth in the true north direction and the light sources 511 and 512 that radiate the visible light may be calculated as an angle between the true north direction and the straight light made by connecting the center point of the reference plane 520 to the center point between the reception positions 521 and 522 of the two beams radiated onto the reference plane 520, using a geometric sensor or the like.

The relative location of the mobile terminal with respect to the light sources for the visible light communication can be calculated using the distance L1 from the two light sources 511 and 512, the incident angle θ2 and the angle θ1.

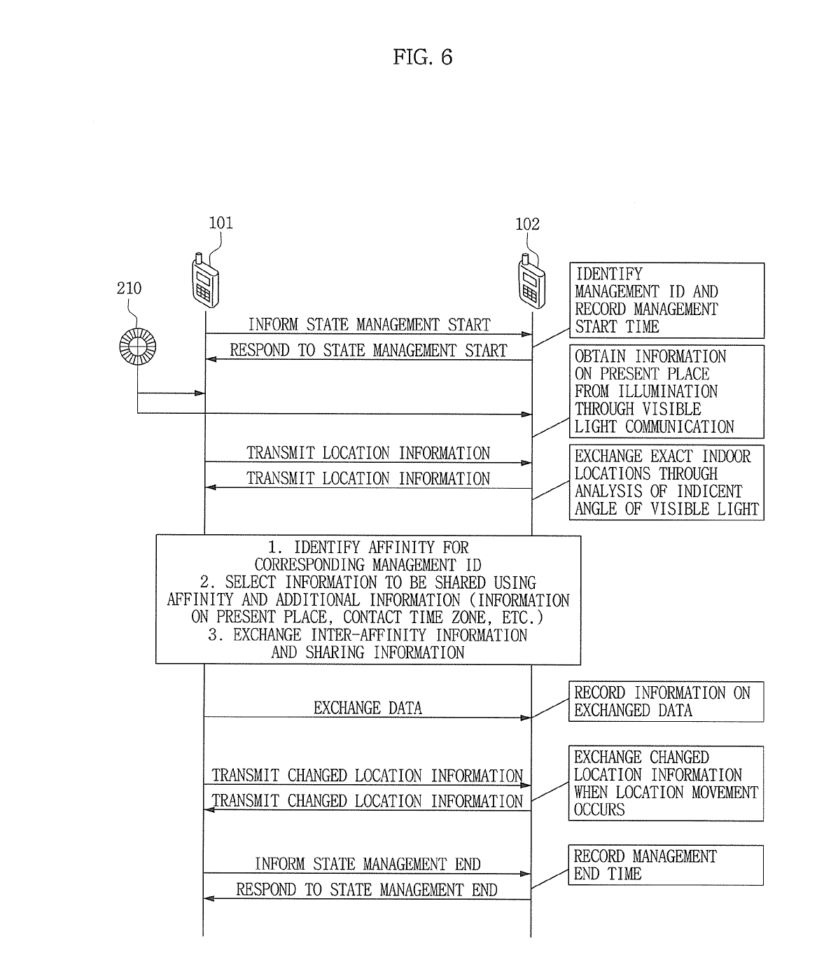

FIG. 6 is a view illustrating a process of providing an SNS using a mobile terminal according to an exemplary embodiment.

Referring to FIG. 6, the first and second mobile terminals 101 and 102 form a network through the same light source 210 that radiates visible light. If the first mobile terminal 101 activates the second mobile terminal 102 to enter a state management start operation through the light source 210, the second mobile terminal 102 responds to the state management start activation. For example, the second mobile terminal 102 may identify management ID and record management start time. Thereafter, the first and second mobile terminals 101 and 102 may calculate location information from the light source 210 via visible light communication. For example, as determined in FIGS. 5A to 5F, The first and second mobile terminals 101 and 102 exchange the calculated location information with each other, and inter-affinity may be identified using personal information received by the first and second mobile terminals 101 and 102. The first and second mobile terminals 101 and 102 exchange sharing information with each other, corresponding to a sharing operation based on the inter-affinity. In this instance, the first and second mobile terminals 101 and 102 may share additional personal information based on the sharing operation, or may form an additional network based on the shared personal information. Also, the sharing operation may be readjusted corresponding to the maintenance time of each of the mobile terminals connected to the network, the distance between the mobile terminals and the shared data information. If the locations of the first and second mobile terminals 101 and 102 change, the first and second mobile terminals 101 and 102 calculate new location information and exchange the changed location information with each other. In a case where the network service is requested to terminate, the first mobile terminal 101 messages the second mobile terminal 102 of state management end, to instigate an ending of networking between the device. The second mobile terminals 102 responds to the state management end, thereby ending the network service.

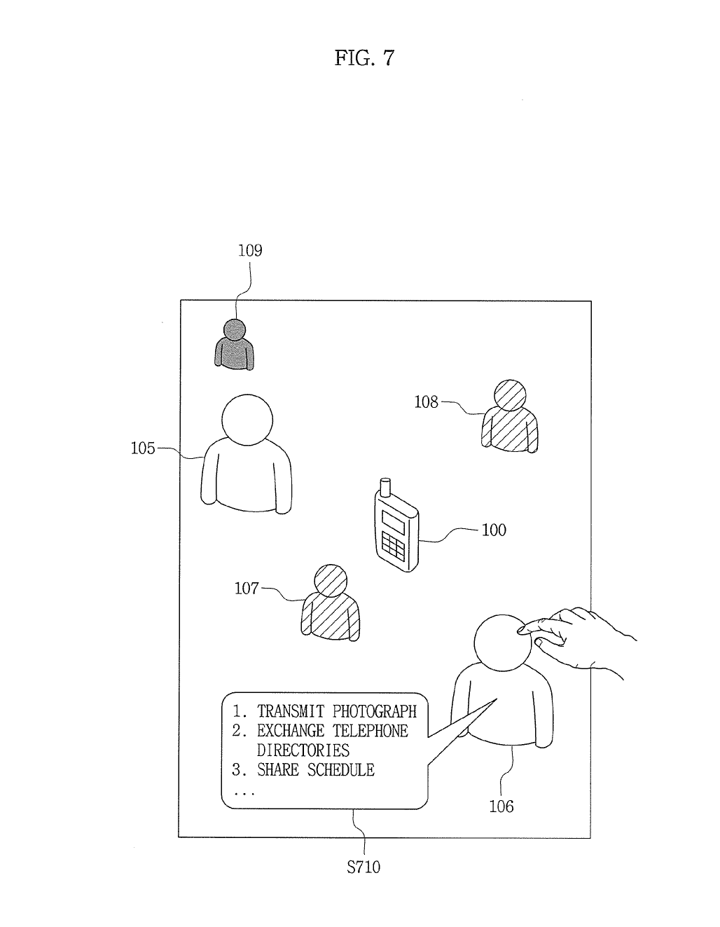

FIG. 7 is a view illustrating a display screen of a mobile terminal that forms a network according to an exemplary embodiment.

Referring to FIG. 7, the mobile terminal 100 and other mobile terminals 105, 106, 107, 108 and 109 that are a network using the visible light communication through the same light source are displayed on a display screen of the mobile terminal 100. While numerous examples in the present disclosure are directed to using the same light source, in other examples, different light sources may be used to achieve similar results. In this instance, the other mobile terminals may be differentiated and displayed, corresponding to a sharing operation based on the distance information from the mobile terminal 100, affinity or the like. In a case where another mobile terminal 106 is selected, menu information applicable in the selected mobile terminal 106 may be displayed on the display screen (S710). A user may then select one of the menu items to facilitate communication between mobile terminal 100 and mobile terminal 106 based on the selection.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, the terminal comprising:
a light reception unit to receive visible light from a light source;
a communication unit to perform communication via the visible light; and
a control unit to control the light source to create a network in which information is transmitted and received to and from another mobile terminal through the communication unit.

2. The mobile terminal according to claim 1, further comprising a calculation unit to calculate location information of the mobile terminal with a vector calculation based on the visible light,
wherein the control unit controls the communication unit based on the calculation result.

3. The mobile terminal according to claim 2, wherein:
the light reception unit comprises a light reception lens,
the calculation unit performs the vector calculation with the light reception lens, by using two light sources and a geomagnetic sensor.

4. The mobile terminal according to claim 1, wherein the control unit controls the light source so that network connection information is transmitted to another mobile terminal.

5. The mobile terminal according to claim 1, wherein the control unit transitions the light source from a first state to a second state.

6. The mobile terminal according to claim 1, wherein the control unit controls the light source so that command information is transmitted to another mobile terminal.

7. The mobile terminal according to claim 1, wherein the control unit receives the network connection information from the light source, to determine the presence of a network connection.

8. The mobile terminal according to claim 1, wherein the control unit receives information of other mobile terminals that communicate via the visible light.

9. The mobile terminal according to claim 1, wherein the control unit transmits request information to identify the presence of the network connection of other mobile terminals at a specific period.

10. The mobile terminal according to claim 1, further comprising a setup unit to set up the presence and range of information sharing between the mobile terminal and other mobile terminals,
wherein the control unit shares information based on the set up of the mobile terminal with other mobile terminals that communicate via the light source.

11. The mobile terminal according to claim 10, wherein the control unit enables sharing of the other mobile terminals, based on the shared information.

12. A communication method for a mobile terminal, the method comprising:
receiving visible light from a light source;
communicating via the visible light; and
transmitting and/or receiving information to and from another mobile terminal using the visible light.

13. The method according to claim 12, wherein the communicating further comprises calculating location information of the mobile terminal with a vector calculation based on the visible light,
the communicating is based on the location information.

14. The method according to claim 12, further comprises receiving information of other mobile terminals that communicate via the visible light.

15. The method according to claim 12, further comprises transmitting request information for identifying the presence of a network connection to other mobile terminals that communicate via the light source at a specific period.

16. The method according to claim 12, wherein the forming of the network further comprises:
setting up sharing information between the mobile terminal and other mobile terminals based on presence and range of information; and
sharing the sharing information between the mobile terminals.

17. A server, comprising:
a light source to radiate visible light;
a communication unit to communicate the visible light to mobile terminals with a specific range; and
a geomagnetic sensor to determine location based on the visible light, wherein the light source has a first light reference source and a second light reference source.
